(19) United States
(12) Patent Application Publication
(10) Pub. No.: US 2008/0134290 A1
(43) Pub. Date: Jun. 5, 2008

(54) Device and Method for Security in Data Communication

(76) Inventor: Mats Olsson, Savedalen (SE)

Correspondence Address: HARNESS, DICKEY & PIERCE, P.L.C., P.O. BOX 8910, RESTON, VA, 20195, US

(21) Appl. No.: 11/660,166

(22) PCT Filed: Aug. 12, 2005
(86) PCT No.: PCT/SE05/01205

§ 371 Date: Sep. 24, 2007

(30) Foreign Application Priority Data
Aug. 17, 2004 (SE) 0402034-3

(51) Int. Cl. G06F 21/00

(52) U.S. Cl. 726/3

(57) ABSTRACT

A device for automatically controlling access between a local area network and a wide area network is disclosed. The device includes a switch which is positioned between the local area network and the wide area network to disconnect the local area network from the wide area network. The switch is further arranged to be automatically controlled based on a system-generated input signal, the signal indicating the expected need for access between the local area network and the wide are network the device being adapted to keep the switch disconnected when the input signal indicates that no need for access between the local area network and the wide area network is expected. Thus, the time during which the local area network is connected to the wide area network, and consequently the time during which the local area network is vulnerable to outside attacks, can be significantly reduced. A method for automatically controlling access between a local area network and a wide area network is also disclosed.

### FIELD OF THE INVENTION

The present invention relates to a device for security in data communication, and more specifically to a device for controlling access between a local area network and a wide area network, said device comprising a switch for disconnecting the local area network from the wide area network. The invention also relates to a method for controlling access between a local area network and a wide area network.

### BACKGROUND ART

Local area networks, such as an intranet in an office, a home network or a network for control and monitoring systems in a building, are today to a great extent constantly connected to wide area networks, such as the Internet. For instance, in office and home computer networks, this allows users of clients in the local computer network to access the Internet at any time, send e-mails etc. Increased occurrence of virus attacks, hacking and unauthorised access from the Internet has, however, made these local area networks vulnerable to outside attacks. It is therefore desirable to be able to temporarily break the contact between the local area network and the wide area network, thereby reducing the time of exposure.

An example of a device for this purpose is disclosed in JP2002-271360, which device is a router which comprises a switch for breaking and closing the contact between a local area network (LAN) and a wide area network (WAN). The switch is manually controlled by a button which is mounted on the upper side of the router. As a result, it will certainly be easy for a user to enable and disable the connection between the LAN and the WAN, but the disadvantage occurs that the user must physically be positioned close to the actual router to control the connection. Above all there is also a risk that the user completely forgets to disconnect the wide area network, or does not bother to disconnect the wide area network due to the extra work of operating the switch on the router, thus leaving the local area network vulnerable to outside attacks.

Moreover, a device is known from WO03/090047, comprising a switch for breaking and closing the contact between an individual computer and a local area network. The control of the switch is dependent on user activity, for instance if the computer is not being used for a certain time, the connection between the computer and the network will be broken. This means that the user does not himself have to bear in mind to disconnect his own computer. The switch can also be manually activated by means of, for instance, a button on the outside of the device, or remote-controlled by a GSM module which is included in the device.

Since the above-mentioned device is controlled depending on an individual user's activity, and aims to protect individual clients, the device is, however, not at all suited for use between a local area network and a wide area network. Besides, in a case involving a local area network comprising a plurality of clients, a device must be installed for each client to protect all clients from outside attacks.

### SUMMARY OF THE INVENTION

An object of the present invention is to provide an improved device for controlling access between a local area network and a wide area network.

A special object of the invention is to provide a device which further reduces the time during which the local area network is connected to the wide area network.

These and other objects, which will be evident from the following description, are achieved by a device for automatically controlling access between a local area network and a wide area network, said device comprising a switch which is positioned between the local area network and the wide area network to disconnect the local area network from the wide area network, said switch being arranged to be automatically controlled based on a system-generated input signal, which signal indicates the expected need for access between the local area network and the wide area network, the device being adapted to keep the switch disconnected when the input signal indicates that no need for access between the local area network and the wide area network is expected.

The invention is based on the knowledge that by automatically controlling the switch based on a system-generated input signal indicating the expected need for access between the local area network and the wide area network, it is possible to significantly reduce the time during which the local area network is connected to the wide area network, and thus the time during which the local area network is vulnerable to outside attacks. Thus, the switch is automatically disconnected (that is the connection between the local area network and the wide area network is broken) when the input signal indicates that no need for the connection between the local area network and the wide area network is expected. On the other hand, the switch is controlled so that the connection is automatically resumed when the input signal indicates that the need for the connection between the local area network and the wide area network is expected. Thus the local area network is connected to the wide area network only when there is a need. For instance, for an office with working hours (that is expected use of the connection between the office intranet and the Internet) between 8 am and 5 pm, this means that the time during which the intranet is connected to the Internet is reduced by almost ⅔ compared with a connection that is on day and night.

A further advantage of the device according to the invention is that the switch does not have to be manually activated, thereby reducing the risk that the connection between the local area network and the wide area network is unnecessarily left on. In addition, the device according to the invention is relatively inexpensive and simple to implement.

By “system-generated” signal is meant within the scope of the present application that the signal is provided by a system without manual operation by, for instance, a user.

The input signal indicating the expected need for access between the local area network and the wide area network can be automatically initiated, that is the actual signal is initiated/generated by the system without manual operation, the signal being automatically “sent” to the device. The device is thus automatically triggered to keep, for instance, the switch disconnected when no need is expected. Again, the advantage is that when the switch is controlled based on an automatically initiated input signal, the setting for access between the networks does not have to be manually controlled, thereby reducing the risk that the connection between the networks is unnecessarily left on.

An input signal indicating the expected need for access between the networks and controlling the switch can be generated by a system which is arranged in the premises accommodating the local area network. The system can, for instance, be included in the actual local area network, or in connection with the premises where the local area network is located. Consequently the connection between the local area network and the wide area network is controlled “from inside” by an internal system, which makes the local area network less vulnerable than in the case where it is controlled from outside, for instance from the wide area network.

The automatic disconnection caused by the input signal indicating that no need for access between the local area network and the wide area network is expected, should not necessarily within the scope of the present application be understood as instantaneous, but includes also a certain delay of the disconnection from a state transition of the input signal. In other words, the total time during which the switch is disconnected is substantially equal to the time the input signal indicates that no need for access between the local area network and the wide area network is expected, but need not necessarily be identical to the same.

The switch can be arranged to disconnect the local area network from the wide area network by physical disconnection. For instance, the actual connection between the networks can be physically broken, or the current feed to a network hub in the switch can be physically broken by a relay so that the local area network is disconnected from the wide area network.

In one embodiment of the invention, the input signal indicating the expected need for access between the local area network and the wide area network is generated by a system indicating the presence of users in premises with access to the local area network. The local area network can be, for instance, a local computer network, such as an intranet, and the premises can be, for instance, an office where clients connected to the local area network (intranet) are accommodated. When there are people/users in the office, there is an expected need for access between the local area network and the wide area network, in which case an input signal is generated which makes the switch allow access between the networks. On the other hand, when there are no people in the office, there is no expected need for access between the local area network and the wide area network, in which case an input signal keeping the switch disconnected is generated, that is the connection between the networks is broken. An advantage of this is that the connection between the local area network and the wide area network is enabled only when there are people in the premises which allow access to clients in the local area network. Moreover this means that if unauthorised access occurs, this occurs in periods when there are people and resources present to handle the unauthorised access.

The system indicating the presence of users in premises with access to the local area network can be at least one of access control system, burglar alarm system, system for central lighting and/or timer. In the case when the control device according to the invention is connected to a plurality of different systems, the electrical connection between the control device and the systems can be adjusted so that, for instance, the input signal from a certain system is prioritised, or the connection between the networks can be broken only when all connected systems generate a signal indicating that no use of the connection is expected etc. Control based on an input signal from a combination of systems can help to increase security and accuracy in respect of the operation of the control device.

Advantageously the input signal controlling the switch between the local area network and the wide area network is generated by one or more existing presence indicating systems, thus simplifying the installation and keeping the implementation costs down.

In the case involving an access control system, there is sent, when the access control system indicates that there are no people/users in the premises with access to the local network, an input signal making the switch automatically ensure that the connection between the local area network and the wide area network is broken. The absence of people in these premises is a clear indication that no need for access between the local area network and the wide area network is to be expected. Correspondingly, there is sent, when the access control system indicates that at least one person is present in the premises, an input signal making the switch automatically ensure that the local area network is connected to the wide area network.

Similarly, an activated burglar alarm system indicates that no people/users are present in the premises with access to the local area network, in which case a signal is generated making the connection between the local area network and the wide area network be broken, whereas a deactivated burglar alarm system indicates that there are people/users in the premises, in which case access between the local area network and the wide area network is allowed.

Similarly, a system for central lighting can indicate whether there are people in the premises with access to the local area network or not, in which case the connection between the local area network and the wide area network can be controlled accordingly. In particular this is, however, advantageous if the central control of lighting corresponds to the fact that there are still people or that there are no people left.

In the case involving a timer, this can be set to fixed times which correspond to, for example, working hours. This means that the local area network is connected to the wide area network at a certain time of the day (for instance in the morning), and that the connection is broken at another time of the day (for instance in the evening). The timer is advantageously arranged with a calendar function so that the switch can be controlled so that the connection is also down during days off, such as holidays.

In another embodiment of the present invention, the input signal, which indicates the expected need for access between the local area network and the wide area network and controls the switch, is generated by a monitoring system in the local area network. The monitoring system is preferably arranged to generate, when the monitoring system generates an alarm owing to, for instance, an indicated error, an input signal making the local area network connected to the wide area network. This makes it possible for the monitoring system to send a message about the alarm, for example by e-mail, via the wide area network, to an external operator. In this case an alarm thus indicates that the need for access between the local area network and the wide network is expected. When there is no alarm, that is when no need for access between the local area network and the wide area network is expected, the input signal is such that the switch is kept disconnected. The local area network thus is connected to the wide area network only when there is a need, in which case the time during which the local area network is exposed to possible outside attacks is significantly reduced, particularly compared with a connection which is always on. The local area network can be, for instance, a network for control and monitoring systems for a building, and the monitoring system can be, for instance, a PLC which by means of various sensors monitors a lift in a building or the temperature in a certain part of a building etc.

The device according to the invention may further comprise means for manual control of the switch, that is manual control of the access between the local area network and the wide area network. This makes it possible to override the automatically selected setting, which is advantageous, for instance, if the local area network is to be used without access to the wide area network being necessary.

The means for manual control may comprise, for example, a physical actuating means which controls the switch, such as a push button or toggle switch which is mounted outside the device. The physical actuating means allows the switch to be manually connected and disconnected, the connection between the local area network and the wide area network being enabled and disabled, respectively. A timer can advantageously be connected to the physical actuating means so that the connection between the networks in actuation of the push button is active for a predetermined time.

The means for manual control may further comprise means for wireless communication, which allows the switch to be manually remote-controlled from outside. The wireless communication can be provided by means of, for example, a GSM module. The latter makes it possible for an operator or user to disable and enable the connection between the local area network and the wide area network using an ordinary GSM mobile phone, for instance by sending an SMS message. This is advantageous in the case when a user from outside wants to connect to the local area network, for instance, to access the contents of a computer in a local computer network, or to read and send commands to systems in a local area network for control and monitoring systems for a building.

According to another aspect of the invention, a method is provided for automatically controlling access between a local area network and a wide area network, said method comprising the steps of receiving a system-generated input signal indicating the expected need for access between the local area network and the wide area network, and, when the input signal indicates that no need for access between the local area network and the wide area network is expected, automatically disconnecting a switch which is positioned between the local area network and the wide area network to disconnect the local area network from the wide area network, that is the connection the local area network and the wide area network is broken.

### BRIEF DESCRIPTION OF THE DRAWINGS

Currently preferred embodiments will in the following be described with reference to the accompanying drawings, in which

FIG. 1 is a schematic block diagram which illustrates an embodiment of the device for controlling access between a local area network and a wide area network according to the invention,

FIG. 2 is a flow chart which illustrates a method for controlling access between a local area network and a wide area network according to the invention,

FIG. 3 is a schematic sketch which shows a device according to the invention which is implemented at a local computer network, and

FIG. 4 is schematic sketch which shows a device according to the invention which is implemented at a local building network.

### DETAILED DESCRIPTION OF PREFERRED EMBODIMENTS

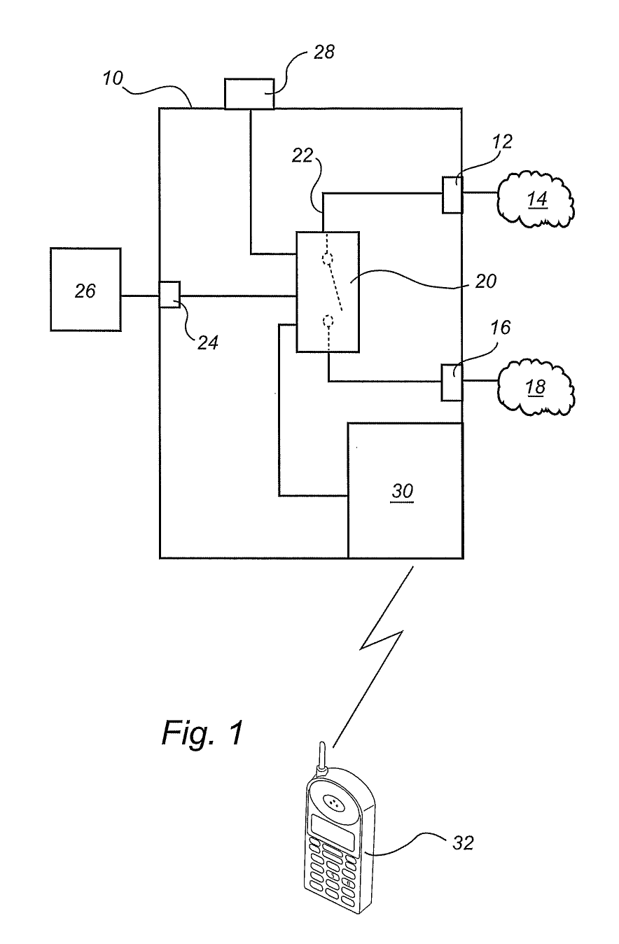

FIG. 1 shows a device 10 for controlling access between a wide area network and a local area network according to an embodiment of the invention. The control device 10 comprises a port 12 for connection to a local area network 14 and a port 16 for connection to a wide area network 18. The control device 10 further comprises a switch 20 which is arranged on a connection 22 between the ports 12 and 16. The switch 20 is arranged to break and close the connection 22 between the local area network 14 and the wide area network 18.

The switch 20 can function in several ways, which is appreciated by a person skilled in the art. For instance the switch may comprise a hub to which the networks 14 and 18 are connected via the connection 22, and a relay which is arranged to physically break the connection to the power feed of the hub, thus breaking the connection between the local area network and the wide area network. The switch can alternatively be arranged to physically break and close the actual connection 22 between the networks.

The device 10 further comprises a port 24 for receiving an input signal from a system 26, which input signal is arranged to automatically control the switch 20.

Moreover the control device 10 may further comprise a manually activatable switch 28, for instance a push button or toggle switch, mounted on the outside of the device 10 and connected to the switch 20, for manual control of the switch 20. A timer can be connected to the switch 28 so that the connection between the networks, when the connection is manually enabled by the switch 28, is active for a predetermined time.

The control device 10 may also comprise a GSM module 30 which is connected to the switch 20. The GSM module 30 allows manual remote control of the switch 20 by receiving commands from a mobile phone 32. The GSM module preferably comprises a register of the phone numbers that are allowed to give control commands to the switch 20, that is from which phone numbers/subscriptions the connection between the local area network and the wide area network can be remote-enabled. The GSM module may further preferably store an event log showing incoming numbers, times, commands etc.

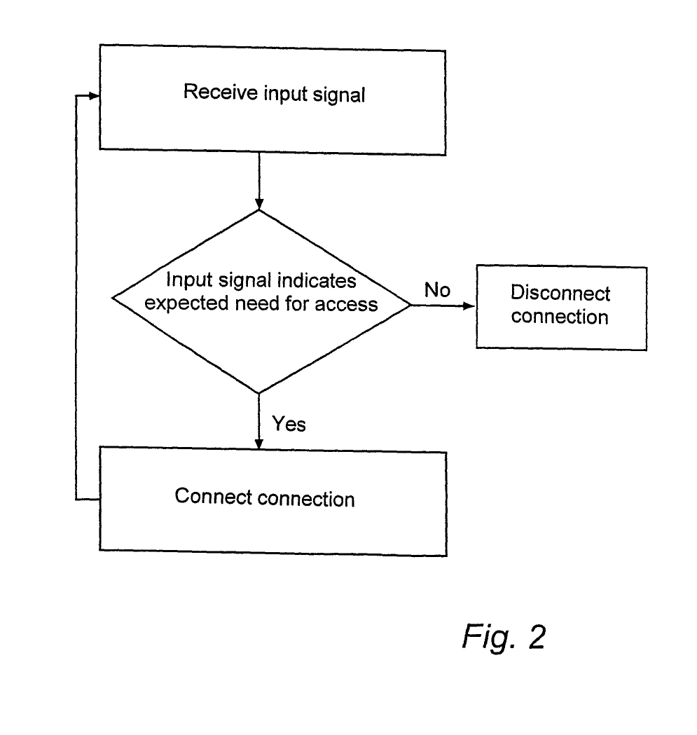

In operation of the control device 10, an input signal generated by the system 26 is received on the port 24. The actual signal is automatically initiated by the system 26. The input signal has a level indicating the expected need for access between the local area network and the wide area network. When no need for the connection between the local area network and the wide area network is expected, the input signal has a level which keeps the switch 20 disconnected, that is the connection 22 between the local area network and the wide area network is broken. When the need for the connection between the local area network and the wide area network is expected, the input signal has a level which keeps the switch 20 closed, that is the connection 22 between the local area network and the wide area network is established. In this manner, the local area network is connected to the wide area network only when the need for access between the local area network and the wide area network is expected. The method described above is summarised in FIG. 2. It should be noted that the input signal received on the port 24 can be delayed, so that disconnection occurs with a predetermined delay, that is the connection between the networks is broken a certain time after the input signal from the system 26 has indicated that there is no need for connection between the networks. The delay can be provided by a suitable electrical connection between the system and the control device.

Alternatively, the switch 20 can be controlled manually by the switch 28. In this way, the automatic control can be overridden. The switch 20 can also be manually remote-controlled by the GSM module 30. Commands to the GSM module are suitably sent in the form of an SMS message from a mobile phone with an authorised subscription/phone number.

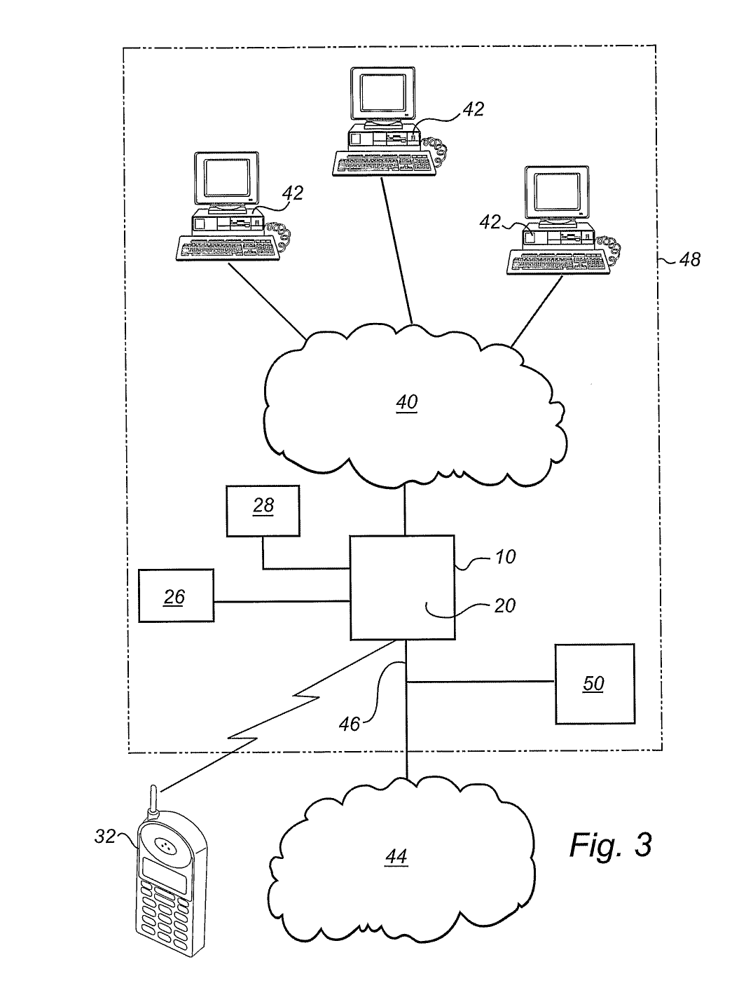

FIG. 3 is a schematic sketch showing a control device 10 according to FIG. 1 implemented adjacent to a local computer network 40, such as an intranet. The local computer network 40 comprises a plurality of workstations 42 and is connected to a wide area network 44, such as the Internet, via a connection 46. The inventive control device 10 is connected between the intranet 40 and the Internet 44 as shown in FIG. 3.

The device 10 is further connected to a system 26, which system generates an input signal which automatically controls the switch 20 in the device 10. In this case the switch is advantageously controlled by an input signal from a system which indicates the presence of users in premises 48 with access to the local area network, that is the presence of people in the premises where the workstations 42 are placed. When the system 26 indicates that there are no people in the premises 48, an input signal with a first level is sent, so that the switch 20 breaks the connection 46, while, when the system indicates that there are people in the premises, an input signal with another level is sent, which is different from the first level, so that the switch 20 closes the connection 46, thereby allowing access between the intranet and the Internet. The input signal controlling the switch is automatically provided by the presence indicating system, that is no manual operation is required to initiate the actual signal.

In one embodiment of the invention, the system 26 generating the input signal to the switch 20 is an access control system which is connected to the premises 48. The access control system is arranged so that each person authorised to access the premises 48 registers in the system each time he or she arrives at the premises or leaves the premises. The access control system can in this way indicate whether there is a person in the premises 48 or not. When the access control system indicates that are no people in the premises 48, a signal is sent to the control device 10, which signal has a level so that the switch 20 breaks the connection 46 between the intranet 40 and the Internet 44. Correspondingly, when the access control system indicates that at least one person is present in the premises 48, a signal is sent to the control device 10 so that the switch 20 automatically ensures that the intranet 40 is connected to the Internet 44. As stated above, the signal is sent automatically, without manual operation.

In another embodiment of the invention, the system 26 generating the input signal to the switch 20 is a burglar alarm system which monitors the premises 48. The alarm system can be included, for instance, in an intrusion protection system for a room or building. The alarm system may function, for instance, in such a manner that the last person leaving the premises 48 for the day activates the alarm, while the first person arriving for the day deactivates the alarm. The alarm system can thus indicate whether there is a person in the premises 48 or not. When the alarm system indicates that there is no one in the premises 48, that is when the alarm is activated, a signal is sent to the control device 10, which signal has a level so that switch 20 breaks the connection 46 between the intranet 40 and the Internet 44. Correspondingly, when the alarm system indicates that at least one person is in the premises 48, that is when the alarm is deactivated, a signal is sent to the control device 10 so that the switch 20 automatically ensures that the intranet 40 is connected to the Internet 44.

In another embodiment of the invention, the system 26 which generates the input signal to the switch 20 is a system for central lighting of the premises 48. The system for central lighting can be arranged so that it detects whether there is a person in the premises 48 or not, for instance by motion or acoustic detectors. The system for central lighting can thus indicate whether there are people in the premises 48 or not, and in the same way as described above send a signal to the device 10 for automatic triggering of the switch 20 based on the indicated presence of people in the premises.

In yet another embodiment of the invention, the system 26 which generates the input signal to the switch 20 is a timer, which is set to send signals to the control device, which trigger the switch at predetermined times. For instance, for an ordinary office where the staff are normally working between 7.30 am and 5.30 pm, a signal is sent at 7.30 am from the timer to the control device 10 so that the switch 20 automatically ensures that the intranet 40 is connected to the Internet 44. Correspondingly, a signal is sent at 5.30 pm from the timer to the control device, which signal has such a level that the switch 20 breaks the connection 46 between the networks 40 and 44. In this manner, the time during which the intranet is connected to the Internet is reduced by fourteen hours a day compared with normally 24 hours a day. The timer is preferably arranged with a calendar function so that the connection between the networks can be broken during holidays, vacation etc. in order to further reduce the time during which the local area network is connected to the wide area network.

In addition to the above-described automatic control, the switch 20 can also be manually controlled by the manually activatable switch 28, which is mounted at a suitable point in the premises with access to the local area network. The manual control allows the automatic control to be overridden. The switch 20 can also be manually remote-controlled by a mobile phone 32, from which an authorised user can send control commands which are received by the GSM module (not shown) in the device 10. A user can thus from outside enable the connection and connect himself to the local area network, for instance to access the contents of a computer in a local computer network.

It should be noted that the control device 10 is advantageously connected to an existing system for indicating the presence of people in the premises 48, thus reducing the cost of installation. In the case when several (existing) presence indicating systems are available, the system or the systems that is/are considered most appropriate is/are selected. When the control device is connected to several different systems, the electrical connection between the control device and the systems can be adjusted so that, for instance, the input signal from a certain system is prioritised, or so that the connection between the networks cannot be broken until all connected systems generate a signal indicating that no use of the connection is expected etc. It should also be noted that computers or other equipment which must be permanently connected to the Internet, such as servers for e-mail, web servers etc, can be connected outside the control device 10 so that they are not affected by the control device. Such computers or other equipment are designated 50 in FIG. 3. Also an optional firewall is connected outside the control device.

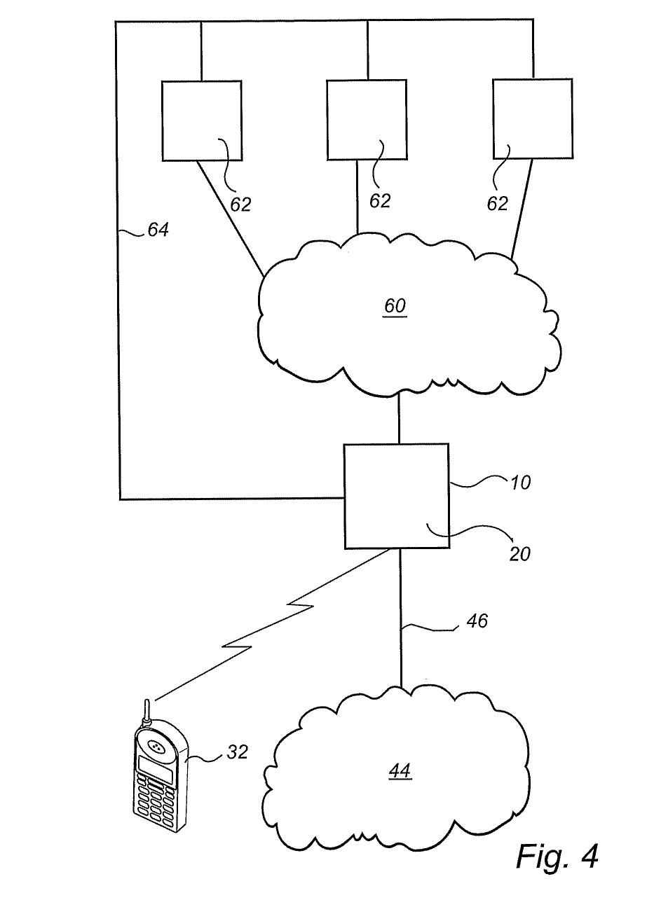

FIG. 4 is a schematic sketch showing a control device 10 according to FIG. 1 which is implemented adjacent to a local area network 60 for control and monitoring systems for a building. The local area network 60 comprises a plurality of control and monitoring systems 62 and is connected to a wide area network 44, such as the Internet, via a connection 46. The control and monitoring systems can be, for instance, PLC units which are connected to and serve the building's heating, ventilation and sanitary installations, cooling systems etc. An operating technician can access these control and monitoring systems, that is the local area network 60, from the Internet in order to, for instance, read status or send commands to the systems. The systems also use the connection to the Internet to send an alarm, for instance via e-mail. The alarm can, for instance, indicate that the lift in the building has stopped, that the cooling system has ceased, that the ventilation has ceased etc.

The inventive control device 10 is connected between the local area network 60 and the Internet 44 as shown in FIG. 4. The switch 20 in the device 10 is in this case automatically controlled based on an input signal from the control and monitoring systems 62, which input signal can, for instance, be sent via a connection 64. When a system 62 sends an alarm, an input signal is sent to the control device, which signal has such a level that the switch 20 closes the connection 46 between the local area network and the Internet. Once the connection between the networks has been established, the alarm can be sent as usual by e-mail. After the alarm has been sent, an input signal is sent, which has another level which is different from the first level, so that the switch 20 breaks the connection 46.

The above-mentioned input signal is system-generated, and no manual operation is required for the actual signal to be sent to the device.

The connection between the local area network and the Internet thus is established only when one of the control and monitoring systems in the local area network needs to send instructions or an alarm via the Internet. This is automatically handled by the control device according to the invention.

In addition to the automatic control of the switch 20 as discussed above, the connection between the local area network and the wide area network can be manually remote-controlled by an authorised mobile phone 32, from which a user can send control commands which are received by the GSM module (not shown) in the device 10. A user can thus from outside manually enable the connection and connect himself to the local area network, for instance to read and/or send commands to the control and monitoring systems 62 in the local area network 60.

The invention is not limited to the embodiments described above. A person skilled in the art will realise that variants and modifications can be made, without deviating from the scope of the invention as defined in the appended claims.

For instance, although a GSM module has been described above, the module for wireless communication can alternatively be based on UMTS, CDMA, etc.

1. A device for automatically controlling access between a local area network and a wide area network, comprising:
a switch, positioned between said local area network and said wide area network, to disconnect the local area network from the wide area network, said switch being automatically controllable based on a system-generated input signal, the signal indicating an expected need for access between the local area network and the wide area network, the device being adapted to keep the switch disconnected when the input signal indicates that no need for access between the local area network and the wide area network is expected.

2. A device as claimed in claim 1, wherein said signal indicating the expected need for access between the local area network and the wide area network is automatically initiated.

3. A device as claimed in claim 1, wherein said signal indicating the expected need for access between the local area network and the wide area network is generated by a system located in premises including the local area network.

4. A device as claimed in claim 1, wherein said switch is arranged to disconnect the local area network from the wide area network by physical disconnection.

5. A device as claimed in claim 1, wherein said signal indicating the expected need for access between the local area network and the wide area network is generated by a system indicating the presence of users in premises with access to the local area network.

6. A device as claimed in claim 5, wherein said system is at least one of access control system, burglar alarm system, system for central lighting, and timer.

7. A device as claimed in claim 1, wherein said signal indicating the expected need for access between the local area network and the wide area network is generated by a monitoring system in the local area network.

8. A device as claimed in claim 1, further comprising means for manual control of said switch.

9. A device as claimed in claim 8, wherein said means for manual control comprises a physical actuating device arranged to be operated by a user.

10. A device as claimed in claim 8, wherein said means for manual control comprises means for wireless communication, allowing the switch to be manually remote-controlled.

11. A device as claimed in claim 10, wherein said means for wireless communication comprises a GSM module.

12. A method for automatically controlling access between a local area network and a wide area network, said method comprising:
receiving a system-generated input signal indicating the expected need for access between the local area network and the wide area network, and
when the input signal indicates that no need for access between the local area network and the wide area network is expected, automatically disconnecting a switch, positioned between the local area network and the wide area network, to disconnect the local area network from the wide area network.

13. A method as claimed in claim 12, wherein said signal indicating the expected need for access between the local area network and the wide area network is automatically initiated.

14. A method as claimed in claim 12, wherein said signal indicating the expected need for access between the local area network and the wide area network is generated by a system located in premises including the local area network.

15. A method as claimed in claim 12, wherein said switch is arranged to disconnect the local area network from the wide area network by physical disconnection.

16. A method as claimed in claim 12, wherein said signal indicating the expected need for access between the local area network and the wide area network is generated by a system indicating the presence of users in premises with access to the local area network.

17. A method as claimed in claim 16, wherein said system is at least one of access control system, burglar alarm system, system for central lighting, and timer.

18. A method as claimed in claim 12, wherein said signal indicating the expected need for access between the local area network and the wide area network is generated by a monitoring system in the local area network.

19. A method as claimed in claim 12, further comprising the step of manually controlling said switch.

20. A device as claimed in claim 2, wherein said signal indicating the expected need for access between the local area network and the wide area network is generated by a system located in premises including the local area network.

21. A method as claimed in claims 13, wherein said signal indicating the expected need for access between the local area network and the wide area network is generated by a system located in premises including the local area network.
